(19) United States
(12) Patent Application Publication
(10) Pub. No.: US 2020/0027117 A1
(43) Pub. Date: Jan. 23, 2020

(54) Real-Time Trusted Blockchain Attribution Platform

(71) Applicant: Cobuna Brands, LLC, Palm Beach Gardens, FL (US)

(72) Inventors: Christos M. Cotsakos, Palm Beach Gardens, FL (US); Serge Massicotte, San Carlos, CA (US)

(21) Appl. No.: 16/513,044

(22) Filed: Jul. 16, 2019

Related U.S. Application Data
(60) Provisional application No. 62/699,175, filed on Jul. 17, 2018.

(51) Int. Cl. G06Q 30/02; H04L 9/06; H04L 9/32; G06F 16/9035

(52) U.S. Cl. CPC G06Q 30/0236; G06Q 30/0235; G06Q 30/0205; H04L 2209/38; H04L 9/3297; G06F 16/9035; H04L 9/0643

(57) ABSTRACT

Presented here are systems and methods to efficiently provide an answer to a query regarding an event and a third-party not expressly involved with the event. To efficiently provide the answer, mutually referential data structures can be created, each data structure representing a different aspect of the event. The mutually referential data structures can include references to each other. One or more of the mutually referential data structures can be recorded in a block chain ledger. For example, one data structure can represent a time ordered list of events, another data structure can represent the third-party, event categories, and the events associated with the third-party in the event categories, while another data structure can define the current state and represent most recent events containing an event category. But representing multiple aspects of the transaction, the efficiency of the lookup can be increased by up to eight orders of magnitude.

### CROSS-REFERENCE TO A PREVIOUSLY FILED APPLICATION

This application claims priority to the U.S. Provisional Patent Application Ser. No. 62/699,175, filed Jul. 17, 2018, which is incorporated herein by this reference in its entirety.

### FIELD

Various of the disclosed embodiments concern a real-time trusted blockchain attribution platform.

### BACKGROUND

Influencer marketing is a form of marketing in which focus is placed on influential people rather than the target market as a whole. It identifies the individuals that have influence over potential buyers, and orients marketing activities around these influencers.

Influencer content may be framed as testimonial advertising where they play the role of a potential buyer themselves, or they may be third parties. These third parties exist either in the supply chain, e.g. retailers, manufacturers, etc., or may be so-called value-added influencers, such as journalists, academics, industry analysts, professional advisers, and so on. The influencer (crowd sourced) marketing industry has increased extremely fast over the past years and its global value for Instagram now is estimated to be 1.07 billion U.S. dollars. The rapidly increasing proliferation, credibility and authenticity of nano-influencers and their followers has created an opportunity for a better methodology through which to connect and promote branded products and services with their relevant communities and consumers.

One of the higher hurdles in leveraging influencer marketing is appropriate attribution and the delivery of real-time, paid for performance analytical data.

### SUMMARY

Presented here are systems and methods to efficiently provide an answer to a query regarding an event and a third-party not expressly involved with the event. To efficiently provide the answer, mutually referential data structures can be created, each data structure representing a different aspect of the event. The mutually referential data structures can include references to each other. One or more of the mutually referential data structures can be recorded in a block chain ledger. For example, one data structure can represent a time ordered list of events, another data structure can represent the third-party, event categories, and the events associated with the third-party in the event categories, while another data structure can define the current state and represent most recent events containing an event category. By representing multiple aspects of the transaction, the efficiency of the lookup can be increased by up to one or two orders of magnitude.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 is a top level sub-system view and information flow;

FIG. 2 shows a system functional overview from a blockchain perspective;

FIG. 3 shows a high level blockchain architecture;

FIG. 4 shows fraud protection issues;

FIG. 5 shows blockchain security layers;

FIG. 6 shows network management data security;

FIG. 7 shows real world modelling;

FIG. 8 is an additional figure that shows real world modelling;

FIG. 9 shows tracing and tracking;

FIG. 10 shows an overall view;

FIG. 11 shows partner nodes;

FIG. 12 shows orders from e-commerce;

FIG. 13 shows order event downstream processes;

FIG. 14 shows event from influencer management system; example: send test offer;

FIG. 15 shows event from payout front-end; example: cash-out;

FIG. 16 shows recommender systems for influencers;

FIG. 17 shows recommender systems for customers;

FIG. 18 shows AI for anomaly detection;

FIG. 19 shows top level user Interaction;

FIG. 20 is a flowchart of a computer implemented method to efficiently provide an answer to a query regarding an event and a third-party not expressly involved with the event;

FIG. 21 is a flowchart of a method to increase accuracy and efficiency of providing an answer to a query regarding an event between a first-party identifier (ID) and a second-party ID; and

FIG. 22 shows a diagrammatic representation of a machine in the example form of a computer system within which a set of instructions for causing the machine to perform one or more of the methodologies discussed herein may be executed.

Those skilled in the art will appreciate that the logic and process steps illustrated in the various flow diagrams discussed below may be altered in a variety of ways. For example, the order of the logic may be rearranged, sub-steps may be performed in parallel, illustrated logic may be omitted, other logic may be included, etc. One will recognize that certain steps may be consolidated into a single step and that actions represented by a single step may be alternatively represented as a collection of sub-steps. The figures are designed to make the disclosed concepts more comprehensible to a human reader. Those skilled in the art will appreciate that actual data structures used to store this information may differ from the figures and/or tables shown, in that they, for example, may be organized in a different manner; may contain more or less information than shown; may be compressed, scrambled and/or encrypted; etc.

### DETAILED DESCRIPTION

Various example embodiments will now be described. The following description provides certain specific details for a thorough understanding and enabling description of these examples. One skilled in the relevant technology will understand, however, that some of the disclosed embodiments may be practiced without many of these details.

Likewise, one skilled in the relevant technology will also understand that some of the embodiments may include many other obvious features not described in detail herein. Additionally, some well-known structures or functions may not be shown or described in detail below, to avoid unnecessarily obscuring the relevant descriptions of the various examples.

Presented here are systems and methods to efficiently provide an answer to a query regarding an event and a third-party not expressly involved with the event. To efficiently provide the answer, mutually referential data structures can be created, each data structure representing a different aspect of the event. The mutually referential data structures can include references to each other. One or more of the mutually referential data structures can be recorded in a block chain ledger. For example, one data structure can represent a time ordered list of events, another data structure can represent the third-party, event categories, and the events associated with the third-party in the event categories, while another data structure can define the current state and represent most recent events containing an event category. But representing multiple aspects of the transaction, the efficiency of the lookup can be increased by up to eight orders of magnitude.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this Detailed Description section.

Trusted Attribution Platform Overview

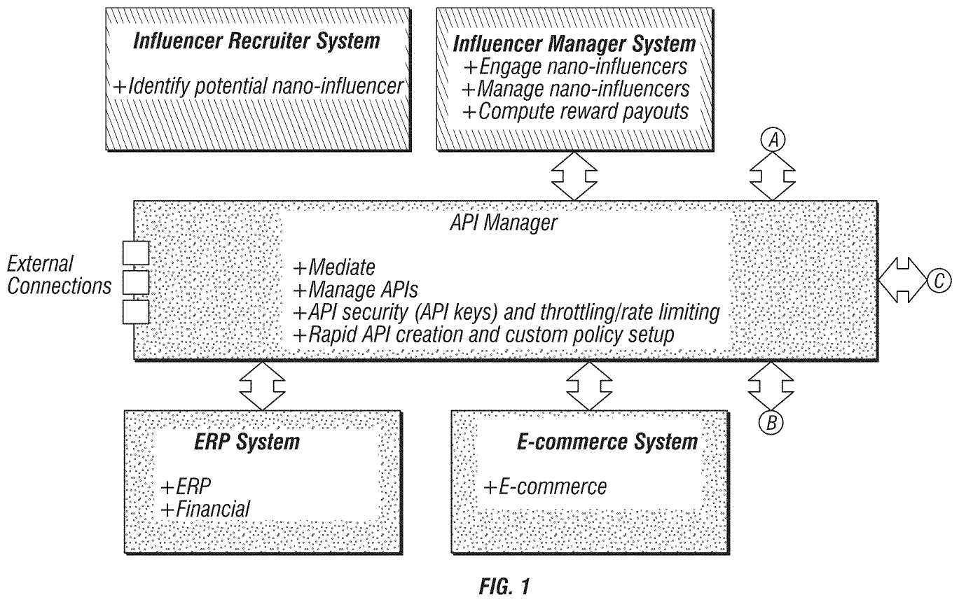

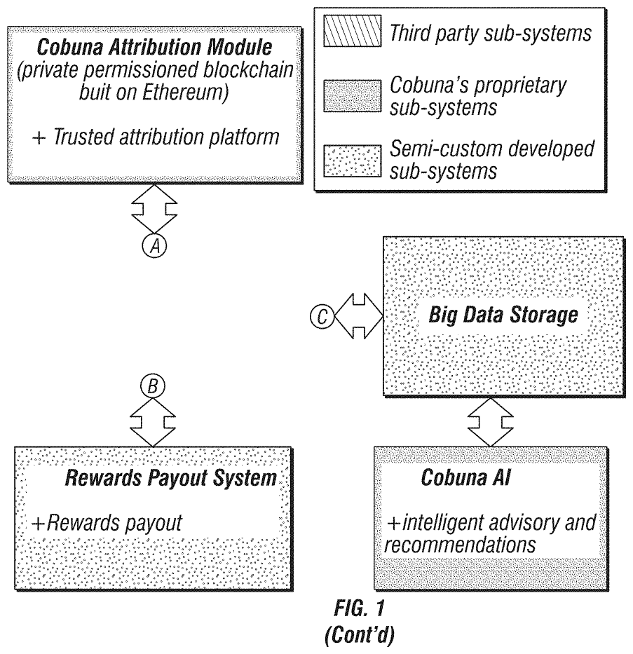

FIG. 1 is a top level sub-system view and information flow in a trusted attribution platform.

Blockchain Architecture

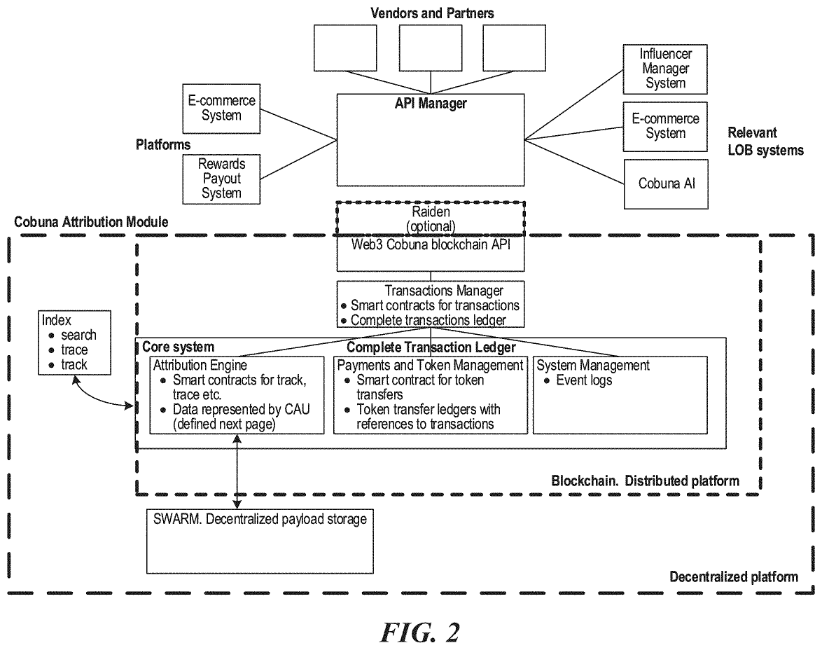

FIG. 2 shows a system functional overview from a blockchain perspective. For the current blockchain we have designed the current system for up to 10 TPS. If the peak usage exceeds 10 TPS we will need to add a tool which permits Ethereum blockchain to scale up to 100 s of TPS. For our purposes, the latter is not likely necessary. An embodiment has been designed with the following in mind:
Transactions scalability and availability. API manager permits large volume of heterogeneous interactions with embodiments in a managed, secured, and scalable manner.
Proof-of-stake consensus algorithm. New algorithm which allows a commitment of high-volume transactions to the blockchain ledger.
Storage scalability. SWARM, a decentralized storage which couples to Ethereum network has been included to ensure storage requirements are manageable over long term.
Rapid response. Search bottleneck of blockchain ledgers is mitigated via an index which permits rapid search, trace and track capabilities, which are important functions for attribution.

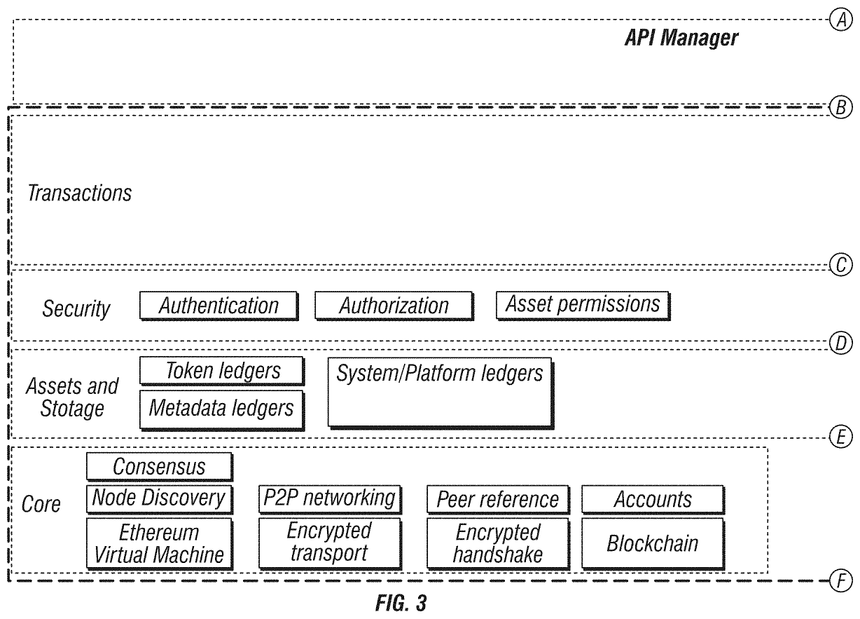

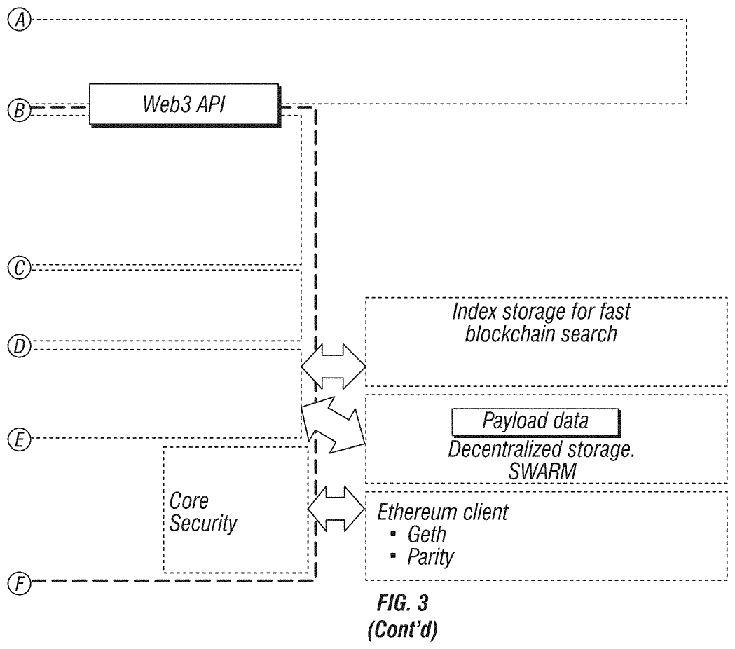

FIG. 3 shows a high level blockchain architecture in a trusted attribution platform.

Governance and Security

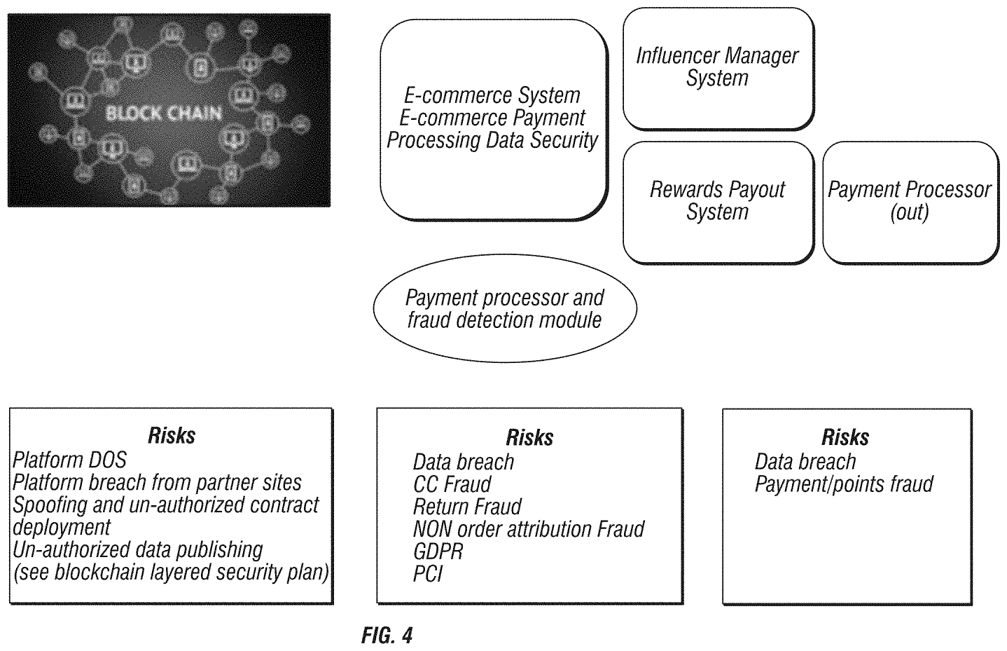

FIG. 4 shows fraud protection issues in a trusted attribution platform.

Fraud from E-Commerce and Payments

Chargeback is the return of funds to a consumer, initiated by the issuing bank of the instrument (such as a credit card) used by a consumer to settle a debt. Specifically, chargeback is the reversal of a prior outbound transfer of funds from a consumer's bank account, line of credit, or credit card. Chargebacks also occur in the distribution industry. This type of chargeback occurs when the supplier sells a product at a higher price to the distributor than the price they have set with the end user. The distributor then submits a chargeback to the supplier so they can recover the money lost in the transaction.

Chargeback fraud, also known as friendly fraud, occurs when a consumer makes an online shopping purchase with their own credit card, and then requests a chargeback from the issuing bank after receiving the purchased goods or services. Once approved, the chargeback cancels the financial transaction, and the consumer receives a refund of the money they spent. When a chargeback occurs, the merchant is accountable, regardless of whatever measures they took to verify the transaction.

Credit card (CC) Chargeback Fraud scoring engine:
Take engagement early to setup and tune.
Avoiding Guaranteed no chargeback services (too many false positives).
Have backup scoring engines if needed.
Third-party plug-ins into attribution ecosystem, e.g. Directscale, Shopify, Netsuite, Tapfiliate, Venmo, among others are fraud protection verified.
Risk: Data security, Return and non-order attribution.
Native data security architecture and has all data encrypted.
Return Fraud: No anomaly engine for Return fraud but can hold returns for validation period.
Non-Order points attribution fraud: No defined feature but will work with us to determine policies, i.e. limit non-orders points to certain ratio v. orders.
Initial thoughts around GDPR but Purge and Download would be manual and we would need to define what we can purge and still have viable financial record.
Would assume additional cost for customization.

GDPR

Blockchain protects privacy in a way consistent with expected regulatory trends as explained below. In fact, blockchain is a key component in Regtech being considered by governments. The present implementation does not store personal and confidential information in the blockchain. Instead, a unique key is stored to refer to user/customer in the e-Commerce. The storage of the unique key provides even more confidentiality than required by the GDPR.

| GDPR Changes | Blockchain |
|---|---|
| Consent. The conditions for consent have | Both blockchain and non-blockchain |
| been strengthened, and companies will no | systems can be used here. While |
| longer be able to use long illegible terms | blockchain based smart contracts can be |
| and conditions full of legalese, as the | used effectively to encode governance |
| request for consent must be given in an | rules which are immutable (which may |
| intelligible and easily accessible form, with | please the regulators), it is recommended |
| the purpose for data processing attached | that we permit flexibility at this point and |
| to that consent. Consent must be clear and | approach it from a non-blockchain |
| distinguishable from other matters and | perspective. We can however use |
| provided in an intelligible and easily | blockchain as an immutable ledger here to |
| accessible form, using clear and plain | flag the consent and consent withdrawal |
| language. It must be as easy to withdraw | decisions. |
| consent as it is to give it. | |
| Breach notification. Under the GDPR, | Since breach reporting is to be done within |
| breach notification will become mandatory | 72 hours of “awareness” and not actual |
| in all member states where a data breach | event, no special automated methods are |
| is likely to “result in a risk for the rights and | required. The immutable nature of |
| freedoms of individuals”. This must be | blockchain can quickly identify any |
| done within 72 hours of first having | attempted data modification. The system |
| become aware of the breach. Data | can be designed so that reports are |
| processors will also be required to notify | produced on demand. |
| their customers, the controllers, “without | |
| undue delay” after first becoming aware of | |
| a data breach | |
| Right to Access. Part of the expanded | As Blockchain will keep the history of |
| rights of data subjects outlined by the | transactions, it could provide proper |
| GDPR is the right for data subjects to | reporting for\ right to access if needed. |
| obtain from the data controller | |
| confirmation as to whether or not personal | |
| data concerning them is being processed, | |
| where and for what purpose. Further, the | |
| controller shall provide a copy of the | |
| personal data, free of charge, in an | |
| electronic format. This change is a | |
| dramatic shift to data transparency and | |
| empowerment of data subjects. | |
| Right to be forgotten. Also known as | The immutable nature of blockchain |
| Data Erasure, the right to be forgotten | means information cannot be erased. |
| entitles the data subject to have the data | However, one way to comply would be via |
| controller erase his/her personal data, | the pseudo-anonymity offered by |
| cease further dissemination of the data, | blockchain as core concept. Our current |
| and potentially have third parties halt | systems maps users to Ethereum |
| processing of the data. The conditions for | accounts via a <key.value> mapping |
| erasure, as outlined in article 17, include | where key is the external identification of |
| the data no longer being relevant to | the user and the value the private key of |
| original purposes for processing, or a data | the account in the blockchain system. |
| subjects withdrawing consent. It should | Given the pseudo-anonymous nature of |
| also be noted that this right requires | blockchain, right to be forgotten could be |
| controllers to compare the subjects' rights | interpreted as removing permanently the |
| to “the public interest in the availability of | link between the account (private key) and |
| the data” when considering such requests. | the external identifier. |
| Data Portability. GDPR introduces data | Blockchain is an effective (perhaps the |
| portability - the right for a data subject to | best) medium for data portability, however |
| receive the personal data concerning | interfaces will need to be developed for it. |
| them, which they have previously provided | |
| in a ‘commonly used and machine- | |
| readable format’ and have the right to | |
| transmit that data to another controller. | |
| Privacy by Design. | Blockchain provides all the mechanisms |
| Privacy by design as a concept has | for privacy by design as it is inherent in the |
| existed for years now, but it is only just | way blockchain platforms have been |
| becoming part of a legal requirement with | designed. Immutable nature of smart |
| the GDPR. At its core, privacy by design | contract means that governance rules |
| calls for the inclusion of data protection | once written cannot be altered. However, |
| from the onset of the designing of systems, | caution is recommended as changes in |
| rather than an addition. More specifically - | regulation will also be difficult to “upgrade” |
| ‘The controller shall implement appropriate | in the future. |
| technical and organizational measures in | |
| an effective way in order to meet the | |
| requirements of this Regulation and | |
| protect the rights of data subjects’. Article | |
| 23 calls for controllers to hold and process | |
| only the data absolutely necessary for the | |
| completion of its duties (data | |
| minimization), as well as limiting the | |
| access to personal data to those needing | |
| to act out the processing. | |

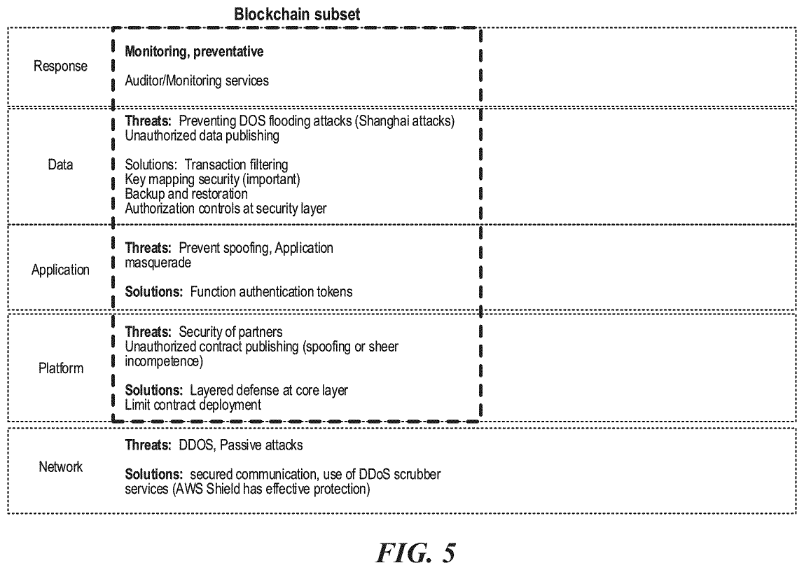

FIG. 5 shows blockchain security layers in a trusted attribution platform. We have considered a security from multiple perspectives. In terms of security layers, in terms of program flow and in terms of project phases. Here we highlight the threats and solutions for blockchain system from a layered security perspective.

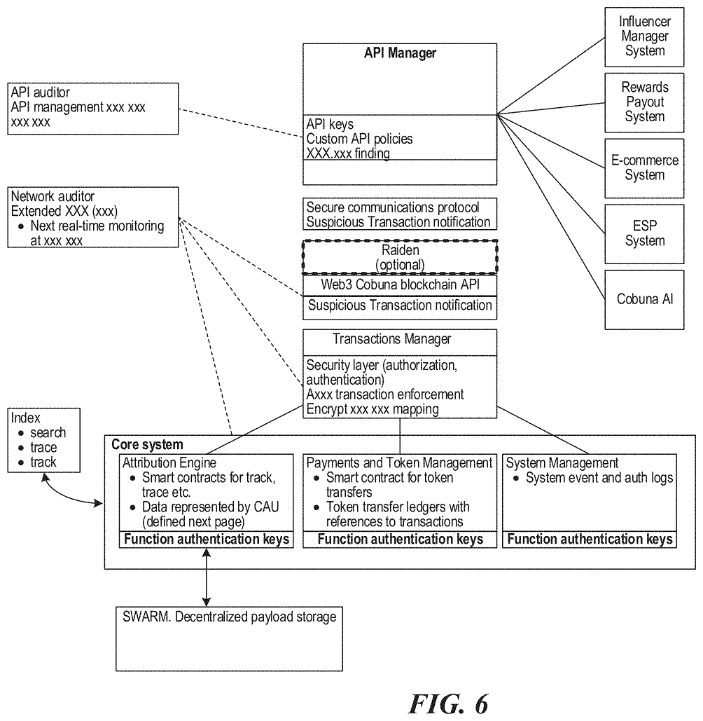

FIG. 6 shows network management data security in a trusted attribution platform. While Authorization and Authentication are taken seriously, Auditing mechanisms have lagged behind significantly in the industry. It is vital from mitigation and response perspective to have proper audit and monitoring tools so that security issues can be detected and remedied. We will enforce a blockchain network auditor built on top of open source Puppeth network manager to monitor blockchain network state. All modern API managers in turn have analytical features for data forensics and auditing which will also be used.

Real World Modelling and Data Representation

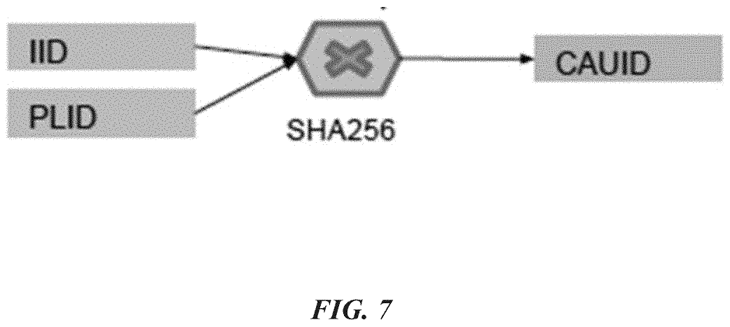

FIG. 7 shows real world modelling in a trusted attribution platform. Influencers are people that have followers. Influencers are represented by an externally obtained unique ID (IID). Influencers subscribe to a certain product line represented by an externally obtained unique ID (PLID). The influencer and product line together form the basic attribution unit which we need to track and trace. How do we efficiently track and trace basic attribution unit? We obtain a globally unique identifier of the system attribution unit by a SHA256 hash of the IID and PLID. This permits direct/random access from hash tables in Ethereum with minimal collision.

How about the details of what helps us track and trace? We define those as attributes which are stored in hash tables permitting direct/random access:
Brand
Purchases influenced
Special offers given out
Test offers given out
Reward earnings
Most recent update (timestamp)

As blockchain is an append only ledger, we also define current state of the CAU as collection of all most recent attributes. Transactions are then defined as events which can change the state of CAU (one or more of the attribute values). Transactions are recorded in a transactions ledger with a reference from the changed attribute to the transaction (event). For fast search and track/trace the off-chain index maintains:
<CAUID, CAU address>, <Tx-ID, CAUID, Attribute, server-timestamp>, <Current state definition>

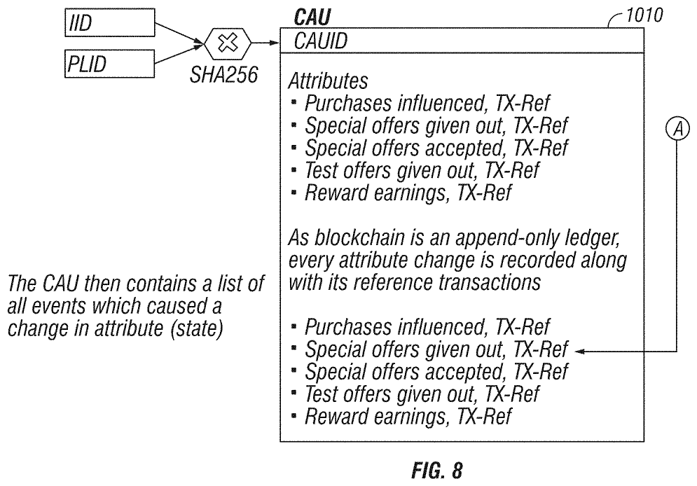

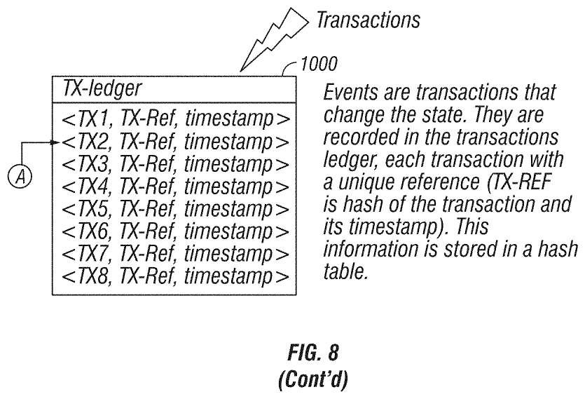

FIG. 8 shows real world modelling in a trusted attribution platform. Events are transactions that change the state. They are recorded in the transactions ledger, each transaction with a unique reference (TX-REF is hash of the transaction and its timestamp). This information is stored in a hash table. The CAU then contains a list of all events which caused a change in attribute (state).

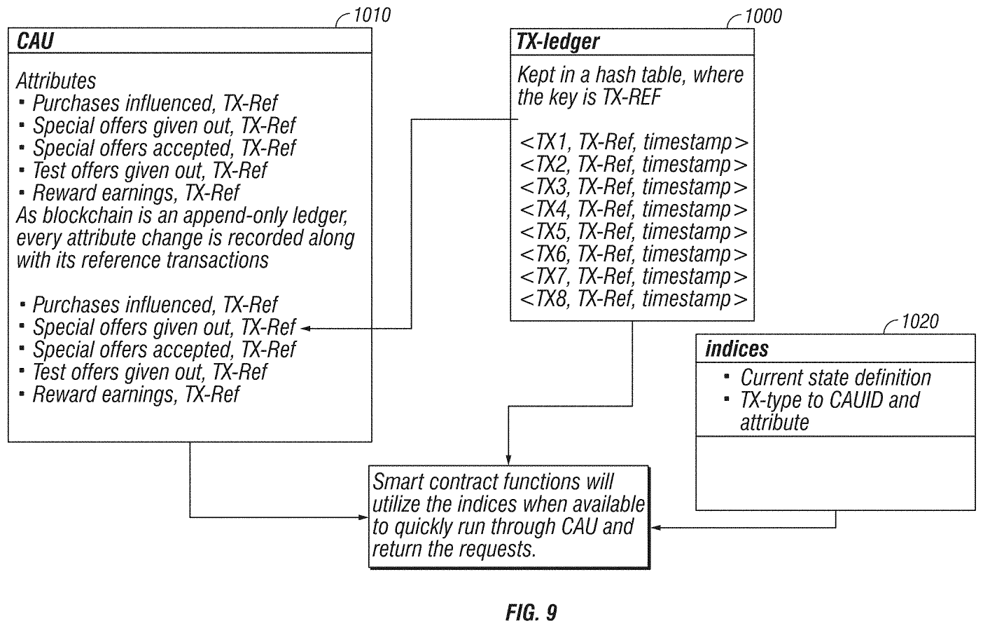

FIG. 9 shows tracing and tracking in a trusted attribution platform. CAUID as a hash makes recollection of all information associated with a CAU simple. Similarly reference transactions ledger has record of all events (transactions which caused changes in state). This makes auditing very simple. Indices are defined which smart contracts can use to trace and track in a fast, efficient manner.

Sample Flows

Basic Approach

We have approached system design from an event-oriented perspective given the interconnections of diverse elements. An API management system manages and mediates messaging in a secure and scalable way.

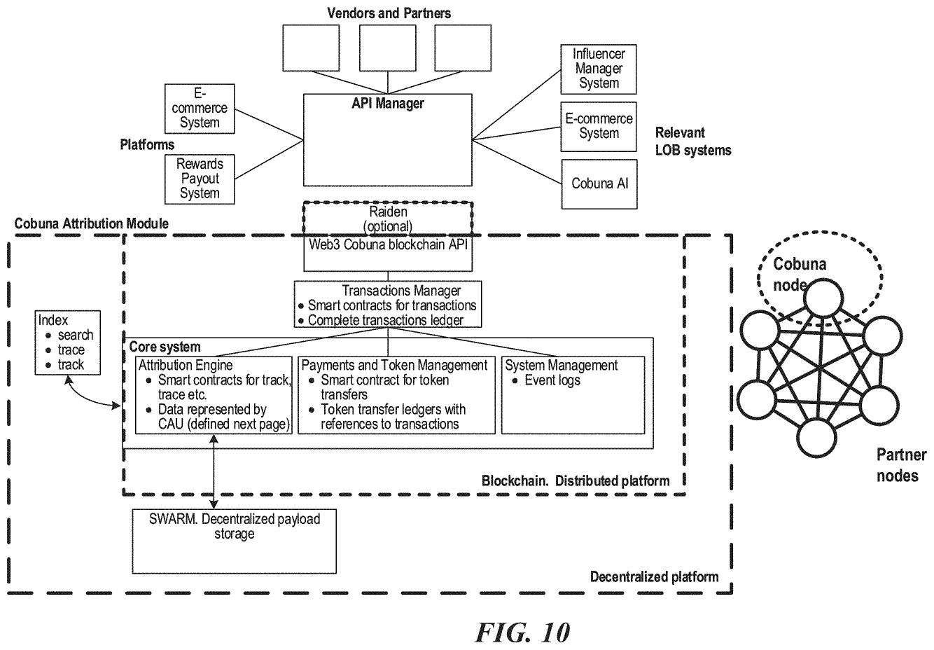

FIG. 10 shows an overall technical view in a trusted attribution platform.

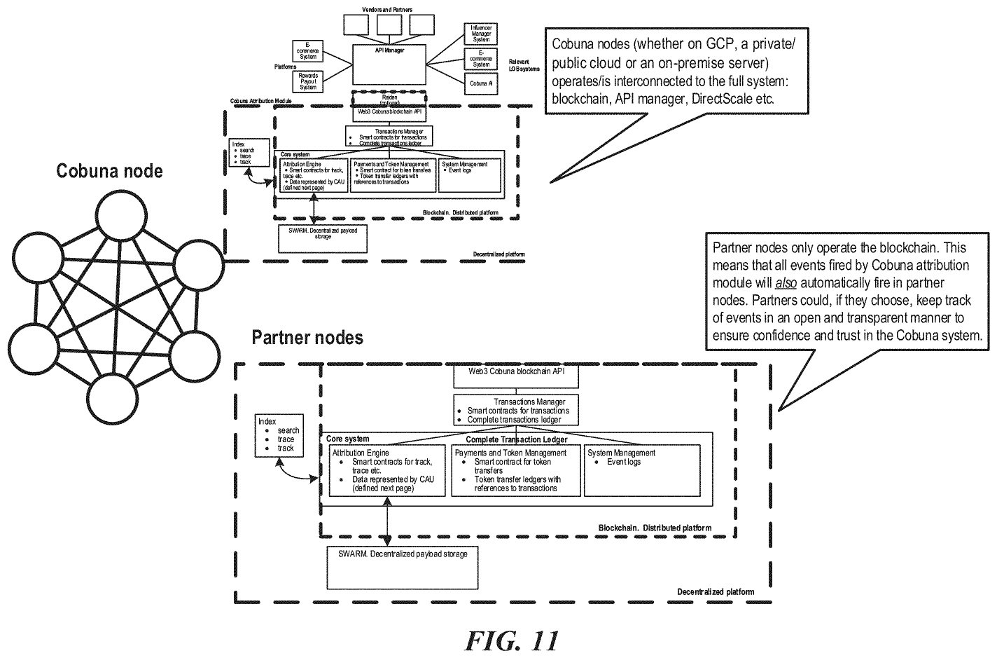

FIG. 11 shows partner nodes in a trusted attribution platform. Cobuna administrator can add and enable partner nodes.

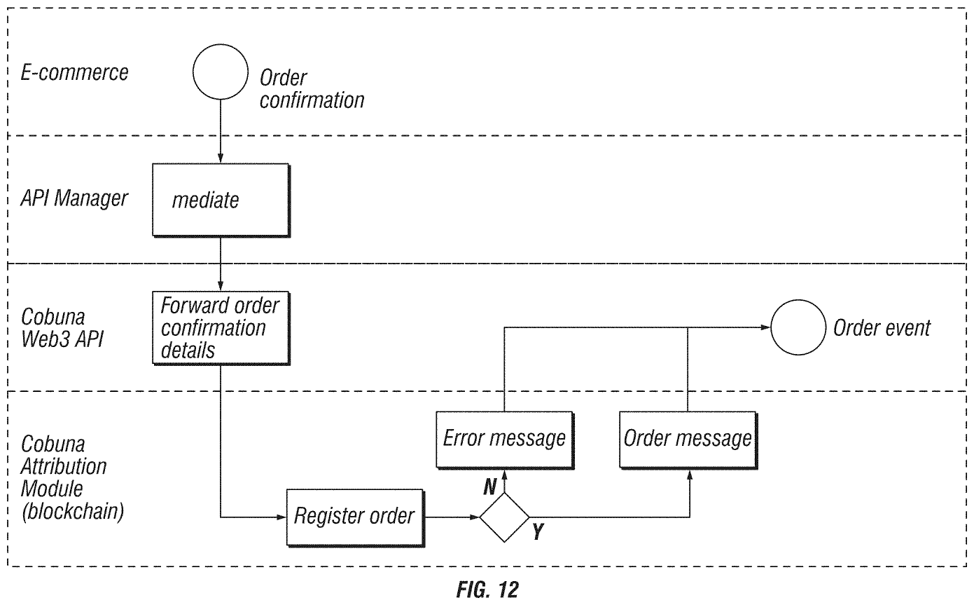

FIG. 12 shows orders from e-commerce in a trusted attribution platform.

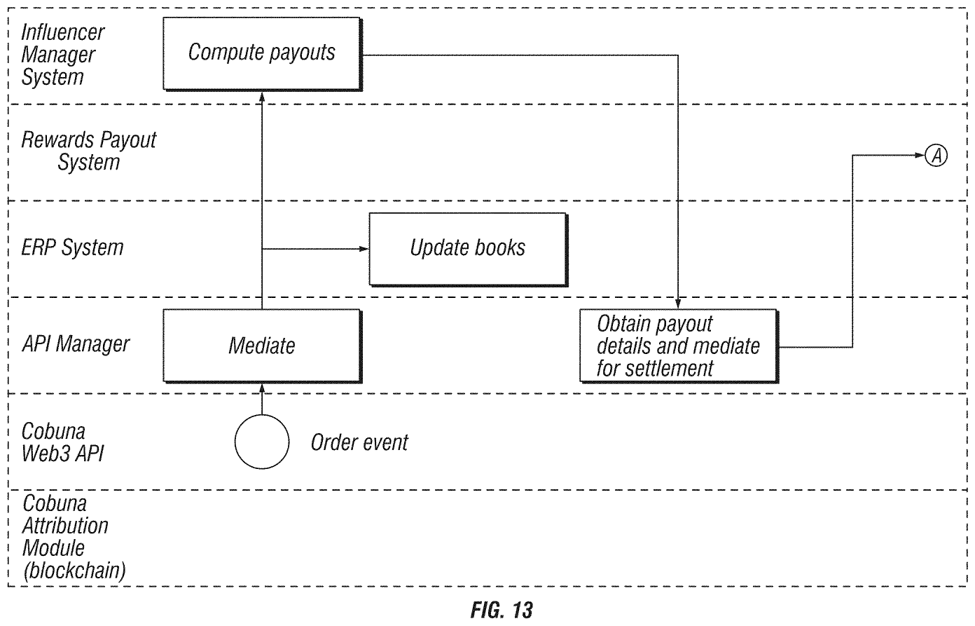

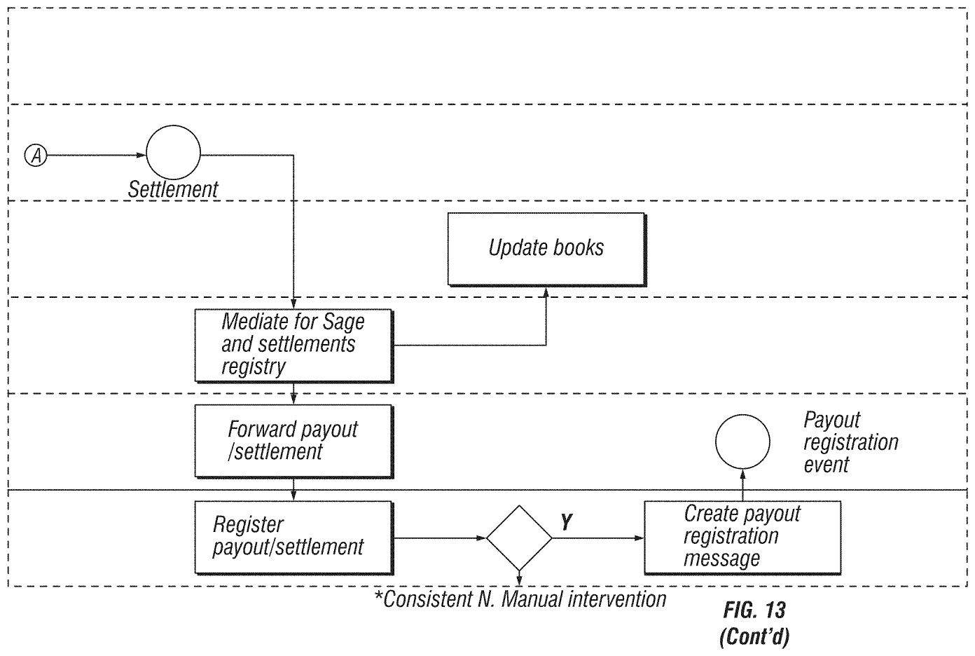

FIG. 13 shows order event downstream processes in a trusted attribution platform.

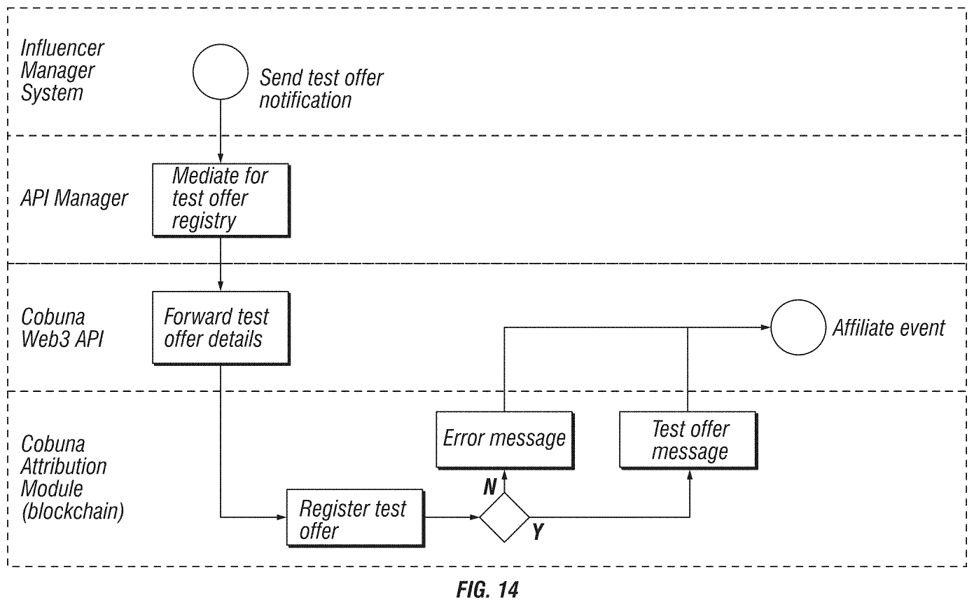

FIG. 14 shows event from influencer management system; example: send test offer in a trusted attribution platform.

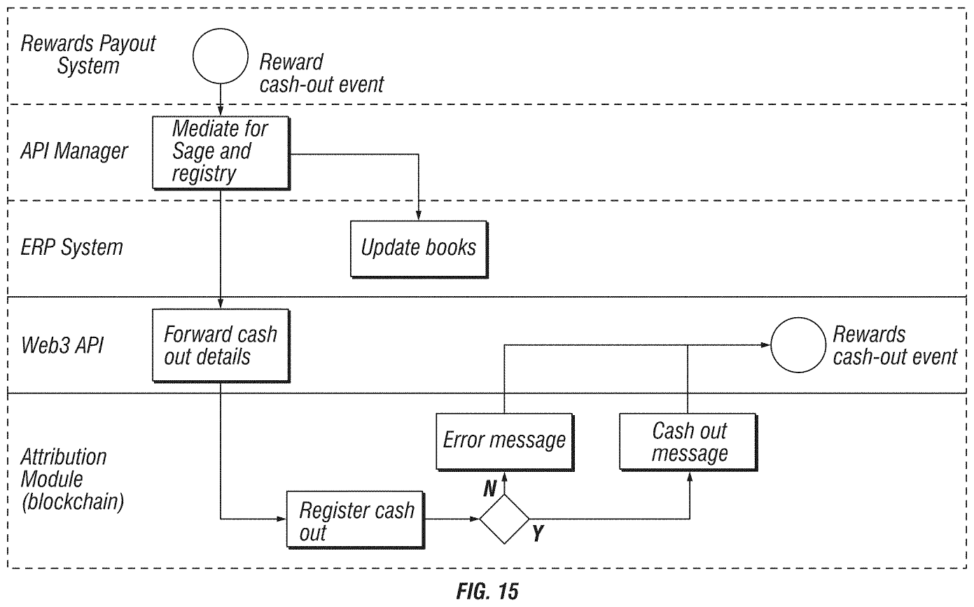

FIG. 15 shows event from payout front-end; example: cash-out in a trusted attribution platform.

AI

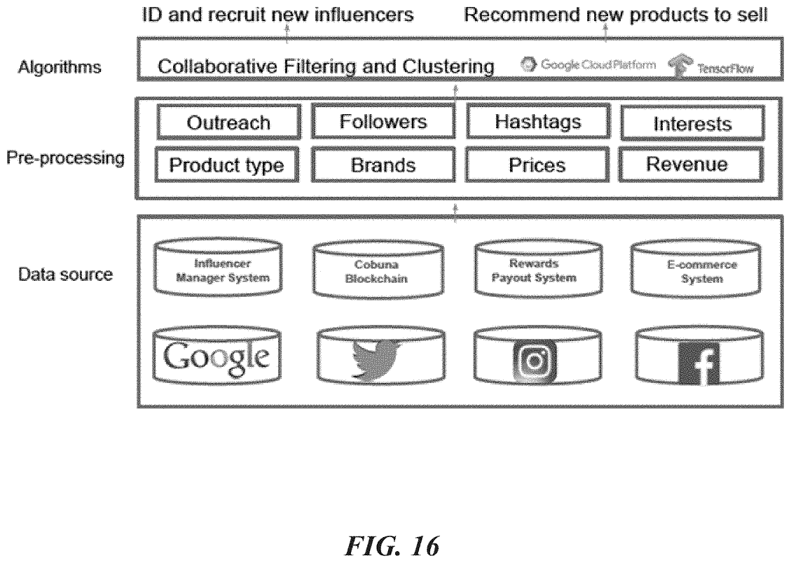

FIG. 16 shows recommender systems for influencers in a trusted attribution platform.

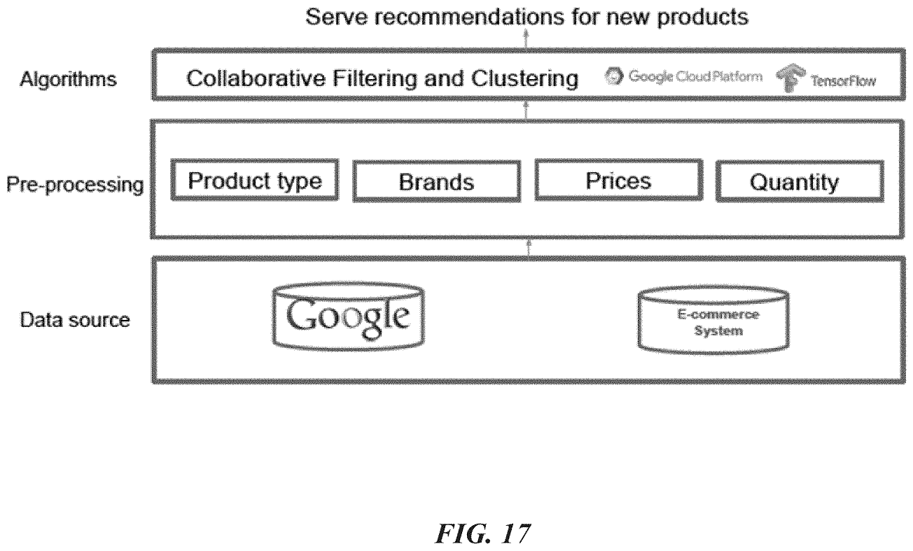

FIG. 17 shows recommender systems for customers in a trusted attribution platform.

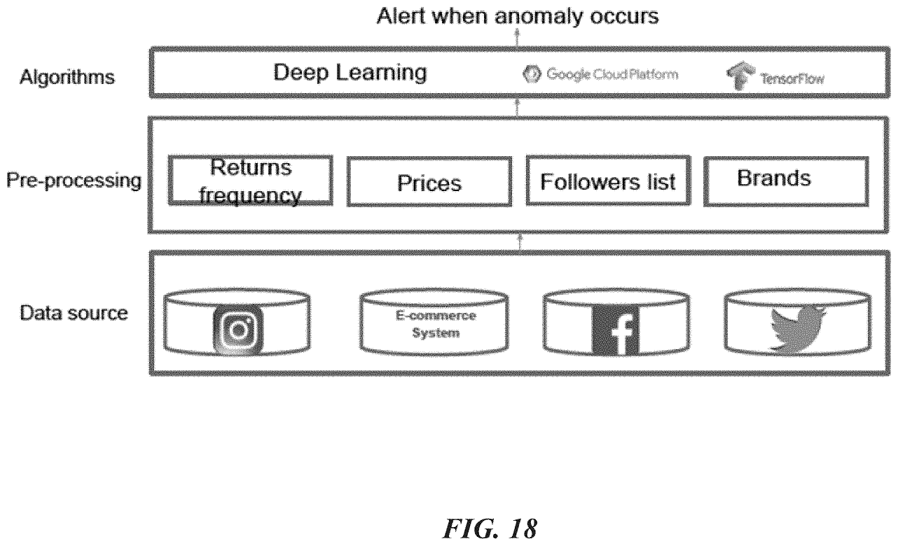

FIG. 18 shows AI for anomaly detection in a trusted attribution platform.

UI/UX

E-Commerce UI/UX

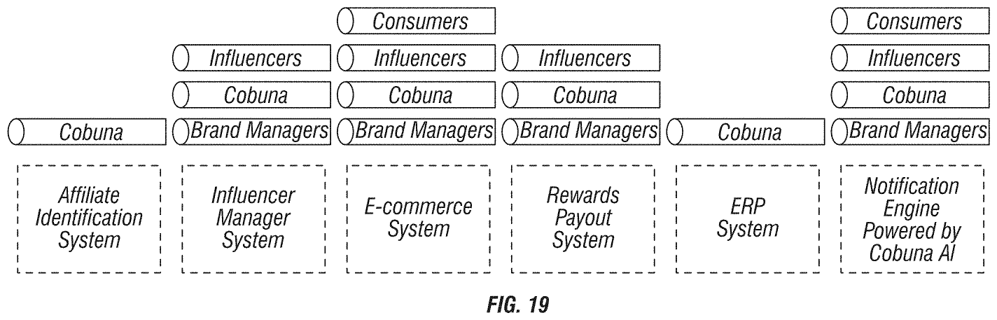

FIG. 19 shows top level user interaction in a trusted attribution platform. The UI/UX design aligns with product branding. Each brand can customize the e-commerce front-end.

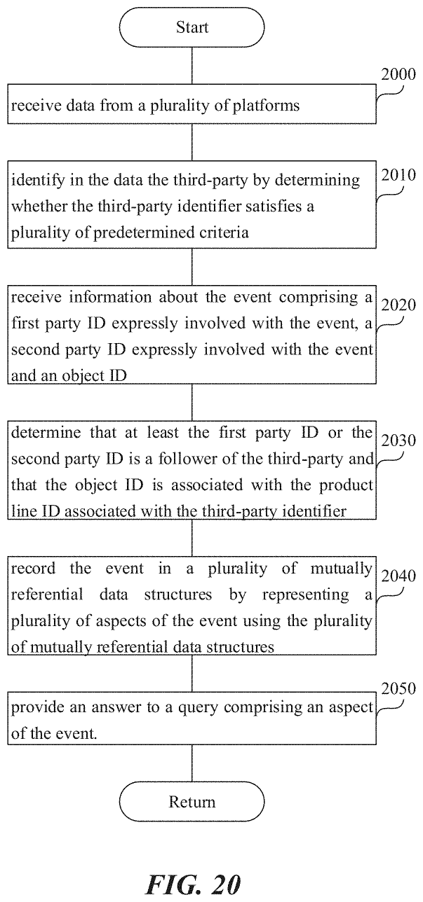

Expanded Flows FIG. 20 is a flowchart of a computer implemented method to efficiently provide an answer to a query regarding an event and a third-party not expressly involved with the event. In step 2000, the processor can receive data from various platforms, such as ones shown in FIG. 18. The received data can include a third-party identifier (ID), a number of followers associated with the third-party ID, a product line ID associated with the third-party ID, outreach, followers, hashtags, interests, brands, prices, revenue, etc. A product line is a group of related products all marketed under a single brand name that is sold by the same company. The IDs as used in this application, such as the third-party ID, the first-party ID, the second-party, the product line ID etc. can be unique.

In step 2010, the processor can identify in the data the third-party ID by determining whether the third-party ID satisfies multiple predetermined criteria. The third-party ID can be an influencer defined by the predetermined criteria. The predetermined criteria can include the number of followers associated with the third-party ID being above a predetermined threshold, and/or the product line ID associated with the third-party ID being on a list of desired products.

For example, the processor can receive a list of desired products, and based on the list can identify the third-party ID from the data received. More specifically, the processor can receive a list of desired product lines such as a Microsoft Office, Nike basketball, Starbucks coffee, etc. The processor can also obtain additional predetermined criteria, such as that the number of followers has to be over a hundred thousand. From the received data, the processor can identify the third-party ID that has at least the desired number of followers, and is associated with at least one of the desired product lines. For example, to determine that the third-party ID is associated with at least one of the desired product lines, the processor can determine that the third-party ID generates information about the product line by, for example, posting on various social media about the product line and/or a product in the product line. If the third-party ID satisfies all the criteria, the third-party ID can be identified as the influencer.

In step 2020, the processor can receive information about the event including a first-party ID expressly involved with the event, a second-party ID expressly involved with the event and/or an object ID. For example, the event can be an exchange of the object ID in the product line ID between the first-party ID and the second-party ID.

In step 2030, the processor can determine that at least the first-party ID or the second-party ID is a follower of the third-party and that the object ID is associated with the product line ID associated with the third-party ID. The processor can do this by matching the first-party ID and/or the second-party ID with a list of followers associated with the various platforms in FIG. 18. In addition, the processor can maintain a collection of product lines associated with each third-party ID, and can determine whether the object ID is part of any of the product line IDs associated with the third-party ID. There can be multiple third-party IDs that can influence a single event between the first-party ID and the second-party ID.

In step 2040, the processor can record the event in multiple mutually referential data structures by representing multiple aspects of the event using the multiple mutually referential data structures and enabling efficient switching between different aspects of the event using references between the multiple mutually referential data structures. A reference between two data structures can enable efficient, e.g. a single step, lookup of information from the one data structure to the other data structure.

The first data structure among the multiple mutually referential data structures can represent a first aspect among multiple aspects. The first data structure can be the TX-ledger 1000 in FIGS. 10-11. The first aspect can include a list of events between multiple first-party IDs and multiple second-party IDs. The first data structure can be maintained in a block chain ledger and can keep a sequential record of every event.

The second data structure in the multiple mutually referential data structures can represent a second aspect including an event category and a reference to the event in the list of events. The second data structure can have multiple parts, where each part is labeled by a unique ID. The unique ID can be a hash of the third-party ID and the product line ID as shown in FIGS. 9-10. So, when the processor receives the third-party ID and an object ID, the processor can determine the product line ID based on the object ID. The processor can perform a hash of the third-party ID and the product line ID, and in a single step access the events associated with the third-party ID for the given product line. The second data structure can be the data structure 1010 as shown in FIGS. 10-11. The second data structure can be recorded in a block chain ledger.

An optional third data structure can represent a third aspect including a collection of most recent events categories. The most recent event categories can be defined as events containing an event category and occurring within a time window from the current time to a predetermined point in the past, such as a day, week a month, etc. The collection of most recent event categories can include a reference to an element of the second data structure and a reference to an element of the first data structure, thus enabling a single step lookup between the third data structure and the second and first data structures. The third data structure can be the data structure 1020 as shown in FIG. 11. Once the lookup has been performed, the processor can request a settlement associated with the third-party ID, as explained in FIGS. 14-17.

In step 2050, the processor can provide an answer to a query including an aspect of the event by finding a data structure in the multiple mutually referential data structures enabling an efficient retrieval of the answer based on the aspect of the event. The various examples of queries are explained below.

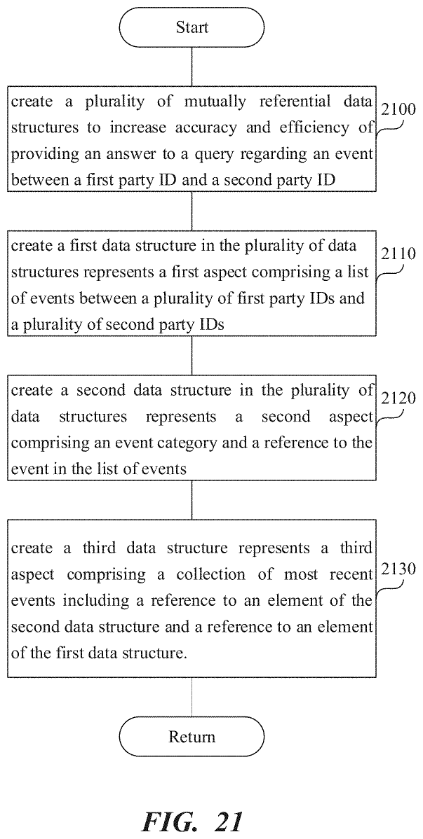

FIG. 21 is a flowchart of a method to increase accuracy and efficiency of providing an answer to a query regarding an event between a first-party ID and a second-party ID. In step 2100, the processor can create multiple mutually referential data structures to increase accuracy and efficiency of providing an answer to a query regarding an event between a first-party ID and a second-party ID. At least one of the first-party ID and the second-party ID can be associated with a third-party ID. The processor can create the multiple mutually referential data structures by representing multiple aspects of the event using the multiple mutually referential data structures and enabling efficient switching between different aspects of the event using references between the multiple mutually referential data structures.

By using the multiple mutually referential data structures, as opposed to just using the first data structure recorded in a block chain ledger, providing answers to queries can be done in real-time. For example, the efficiency of providing answers to queries can be increased from O(N) to O(1), i.e. constant time, where N is the number of entries in the block chain ledger. Therefore, the efficiency gains are highly significant because the number of entries in the block chain ledger can go up to half a billion entries. Consequently, the efficiency gains by using the multiple mutually referential data structures go from approximately half a billion operations to approximately one operation.

In step 2110, the processor can create a first data structure in the multiple mutually referential data structures representing a first aspect including a list of events between multiple first-party IDs and multiple second-party IDs. The first data structure 1000 in FIGS. 10-11 can record the event in a block chain ledger, as shown in FIGS. 10-11. The first data structure can record various events, not all of which are associated with first, second and/or third-party IDs. The first data structure can include an event information, a timestamp associated with the event and a unique identifier of the event, i.e. event ID. The event ID can include a hash of the event and the timestamp of the event. To be able to retrieve information from the first data structure, the processor needs to obtain all the event information and/or the timestamp. Retrieving information by using first, second and/or third-party ID would require extensive searching and matching of the whole first data structure.

In step 2120, the processor can create a second data structure representing a second aspect including an event category and a reference to the event in the list of events. The second data structure can be the data structure 1010 in FIGS. 10-11. The second data structure can include the event category and a collection of events associated with the event category. The second data structure can contain the event category, and each event category can contain a list of events belonging to the event category. The list of events can be arranged by time. Alternatively, the second data structure can be a list arranged by time of one event category and one event belonging to the one event category. The event category can include a purchase influenced, special offer given out, special offer accepted, a test offer given out, and/or a reward earning.

The second data structure can have multiple parts, where each part is labeled by a unique ID. The unique ID can be a hash of the third-party ID and the product line ID. So, when the processor receives the third-party ID and an object ID, the processor can determine the product line ID based on the object ID. The processor can perform a hash of the third-party ID and the product line ID, and in a single step access the events associated with the third-party ID for the given product line. The second data structure can be the data structure 1010 as shown in FIGS. 10-11.

In step 2130, the processor can optionally create a third data structure representing a third aspect including a collection of most recent event categories. The most recent event categories can be defined as events containing an event category and occurring within a time window from the current time to a predetermined point in the past, such as a day, week a month, etc. Each entry in the collection of most recent event categories can include a reference to an element of the second data structure and a reference to an element of the first data structure.

For example, the reference to the element of the first data structure can include the event ID, enabling the single step lookup into the first data structure, from which event information and timestamp can be retrieved. The reference to the element of the second data structure can include the unique ID, e.g. a hash of the third-party ID and the product line ID, and can include a reference to the whole second data structure including the multiple parts. In addition, the third data structure 1020 in FIG. 11 can include the event category, and a timestamp associated with the event. The third data structure can be sorted by the timestamp, and can enable efficient lookup by time. Further, because the third data structure is only a small fraction, i.e. most recent events containing an event category, of all the transactions recorded in the first data structure, searching the third data structure is more efficient than searching the first data structure.

The processor can receive a query including an aspect of the event and can obtain an answer to the query by finding, based on the aspect of the event, a data structure in the multiple mutually referential data structures that enables an efficient retrieval of the answer. Once the appropriate data structure has been identified, the processor can obtain the answer from the data structure, in some instances, with a single lookup. The identified data structure can be a data structure that allows indexing using a whole or a part of the query.

The query including the aspect of the event can take on various forms. In one embodiment, the aspect of the event can include the third-party ID. The processor can determine that the second data structure enables the efficient retrieval of the answer based on the third-party ID, because the second data structure can with a single lookup containing the hash of the third-party ID and the product line ID provide information about the event category the event ID, which can be a reference to the first data structure. The processor can compute the hash of the third-party ID and the available product line IDs to perform the lookup into the second data structure.

In another embodiment, the aspect of the event can include the product line ID. The processor can determine that the second data structure enables the efficient retrieval of the answer based on the product line ID, because the second data structure can with a single lookup containing the hash of the third-party ID and the product line ID provide information about the event category the event ID, which can be a reference to the first data structure. The processor can compute the hash of the product line ID and all the third-party IDs to perform the lookup into the second data structure.

In the third embodiment, the aspect of the event can include both the third-party ID and the product line ID. In any of the above examples, the processor can obtain the answer by retrieving from the second data structure the event category and/or a collection of events associated with the event category.

Providing the answer using the second data structure, as described above, results in an efficient lookup, e.g. a real time lookup, because the time to perform the lookup is O(1) time. O(1) means that, no matter how much data there is in the multiple mutually referential data structures, providing the answer executes in constant time. By contrast, if there was no second data structure, only the first data structure, providing the answer would take O(N) time, where N is the number of entries in the first data structure, which can include half a billion entries. Specifically, searching the first data structure for the third-party ID and/or the product line ID can require searching through the event information of every event stored in the first data structure, to determine whether the event information contains the third-party ID and/or the product line ID. Consequently, performing the method described here increases the efficiency of the lookup N times.

The query can further specify an additional criterion. For example, the additional criterion can specify that the answer should provide all the information retrieved from the second data structure, some of the information retrieved from the second data structure, and/or can specify how the information should be presented, etc. For example, the additional criterion can request that all information associated with the third-party ID and/or product line ID be provided, such as all the event categories and all the events in the event categories. In another example, the additional criterion can request that only the event categories containing events be provided. In a third example, the additional criterion can request that the answer be sorted according to time. The query can contain one or more of the described criteria.

In a fourth embodiment, the aspect of the event can include a time period. The processor can determine that the third data structure enables the efficient retrieval of the answer based on the time period, because the third data structure can contain the most recent events associated with an event category. The processor can obtain the answer to the query by retrieving from the third data structure the event category, the event ID, the third-party ID, a product line associated with the event, or a timestamp associated with the event. The event ID and/or the third-party ID can be used for a single step lookup into the first and/or second data structure, respectively.

Providing the answer using the third data structure, as described above, results in an efficient lookup because the time to perform the lookup is O(M) time, where M is the number of entries in the third data structure. By contrast, if there was no third data structure, only the first data structure, providing the answer would take O(N) time, where N is the number of entries in the first data structure. However, M is much smaller than N because the third data structure only contains the recent events associated with the event category, while the first data structure contains every event recorded, regardless of whether the event is associated with the event category. Consequently, performing the method described here increases the efficiency of the lookup N/M times, where N divided by M is much greater than one.

For example, the third data structure can contain entries associated with an event category within the last month, which can be approximately 5 million entries, i.e. M=5 million. The first data structure can contain approximately half a billion entries, i.e. N=500 million. Thus, providing the answer using the third data structure can be 100 times more efficient than using only the first data structure.

In a fifth embodiment, the aspect of the event can include the reference to the event. The processor can determine that the first data structure enables the efficient retrieval of the answer based on the event information. The processor can obtain the answer by retrieving the event information from the first data structure.

The efficient lookups enabled by the multiple mutually referential data structures enable smart contracts to efficiently retrieve information necessary to form a contract. For example, to form the smart contract, processor can have the third-party ID and the product ID, but need the information including the event information such as the second-party ID and the first-party ID. Given the mutually referential data structures, the processor can perform a single step lookup into the second data structure to retrieve all of the events in which the third-party was indirectly involved. The processor can provide all the event categories and event IDs associated with the third-party and the product line in O(1) time. Further, the processor can provide all the event information in O(1) by referencing the first data structure using the event ID, and retrieving the event information from the first data structure. By contrast, without the mutually referential data structures, retrieving the event information will require O(N), where N is the number of entries in the first data structure. As explained above, N is a very large number because the first data structures contains all the events ever recorded.

Computer System

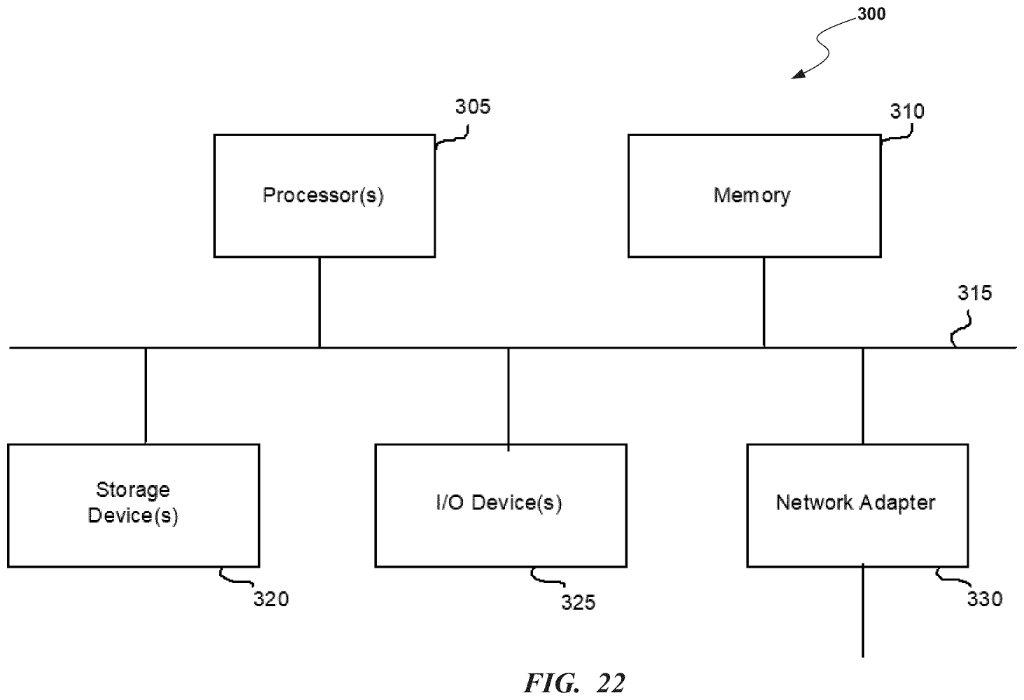

FIG. 22 is a block diagram of a computer system as may be used to implement certain features of some of the embodiments. The computer system may be a server computer, a computer in a cloud computing platform, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions (sequential or otherwise) that specify actions to be taken by that machine.

The computing system 300 may include one or more central processing units (“processors”) 305, memory 310, input/output devices 325, e.g. keyboard and pointing devices, touch devices, display devices, storage devices 320, e.g. disk drives, and network adapters 330, e.g. network interfaces, that are connected to an interconnect 315. The interconnect 315 is illustrated as an abstraction that represents any one or more separate physical buses, point to point connections, or both connected by appropriate bridges, adapters, or controllers. The interconnect 315, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called Firewire.

The memory 310 and storage devices 320 arc computer-readable storage media that may store instructions that implement at least portions of the various embodiments. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media.

The instructions stored in memory 310 can be implemented as software and/or firmware to program the processor 305 to carry out actions described above. In some embodiments, such software or firmware may be initially provided to the processing system 300 by downloading it from a remote system through the computing system 300, e.g. via network adapter 330.

The various embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

1. A computer implemented method to efficiently provide an answer to a query regarding an event and a third-party identifier (ID) not expressly involved with the event, the method comprising:
receiving data from a plurality of platforms, the data comprising a third-party ID, a number of followers associated with the third-party ID, a product line ID associated with the third-party ID;
identifying in the data the third-party ID by determining whether the third-party ID satisfies a plurality of predetermined criteria comprising the number of followers associated with the third-party ID being above a predetermined threshold, and the product line ID associated with the third-party ID being on a list of desired products;
receiving information about the event comprising a first-party ID expressly involved with the event, a second-party ID expressly involved with the event and an object ID;
determining that at least the first-party ID or the second-party ID is a follower of the third-party ID and that the object ID is associated with the product line ID associated with the third-party ID;
recording the event in a plurality of mutually referential data structures by representing a plurality of aspects of the event using the plurality of mutually referential data structures and enabling efficient switching between different aspects of the event using references between the plurality of mutually referential data structures,
wherein a first data structure in the plurality of mutually referential data structures represents a first aspect comprising a list of events between a plurality of first-party IDs and a plurality of second-party IDs, and
wherein a second data structure in the plurality of mutually referential data structures represents a second aspect comprising an event category and a reference to the event in the list of events,
wherein a third data structure represents a third aspect comprising a collection of most recent events including the event category, a reference to an element of the second data structure and a reference to an element of the first data structure; and
providing the answer to the query comprising an aspect of the event by finding a data structure in the plurality of mutually referential data structures enabling an efficient retrieval of the answer based on the aspect of the event.

2. The method comprising:
creating a plurality of mutually referential data structures to increase efficiency of providing an answer to a query regarding an event between a first-party ID and a second-party ID, wherein at least one of the first-party ID and the second-party ID is associated with a third-party ID, by representing a plurality of aspects of the event using the plurality of mutually referential data structures and enabling efficient switching between different aspects of the event using references between the plurality of mutually referential data structures, said creating comprising:
creating a first data structure in the plurality of mutually referential data structures representing a first aspect comprising a list of events between a plurality of first-party IDs and a plurality of second-party IDs; and
creating a second data structure in the plurality of mutually referential data structures representing a second aspect comprising an event category and a reference to the event in the list of events.

3. The method of claim 2, the first data structure comprising an event information and a timestamp associated with the event.

4. The method of claim 3, the first data structure comprising an event ID including a hash of the event information and the timestamp associated with the event.

5. The method of claim 2, the second data structure comprising the event category and a collection of events associated with the event category.

6. The method of claim 5, the event category comprising a purchase influenced, special offer given out, special offer accepted, a test offer given out, and a reward earning.

7. The method of claim 6, comprising creating a third data structure representing a third aspect comprising a collection of most recent events including the event category, a reference to an element of the second data structure and a reference to an element of the first data structure.

8. The method of claim 7, the third data structure comprising an event ID, a hash of the third-party ID and a product line ID associated with the event, the event category, and a timestamp associated with the event.

9. The method of claim 2, comprising:
receiving the query comprising an aspect of the event;
obtaining the answer to the query by finding a data structure in the plurality of mutually referential data structures enabling an efficient retrieval of the answer based on the aspect of the event; and
obtaining the answer from the data structure.

10. The method of claim 9, wherein the aspect of the event comprises the third-party ID, the method comprising:
determining that the second data structure enables the efficient retrieval of the answer based on the third-party ID; and
obtaining the answer by retrieving from the second data structure the event category or a collection of events associated with the event category.

11. The method of claim 9, wherein the aspect of the event comprises a time period, the method comprising:
determining that a third data structure comprising a collection of most recent events including the event category, a reference to an element of the second data structure and a reference to an element of the first data structure enables the efficient retrieval of the answer based on the time period; and
obtaining the answer by retrieving from the third data structure the event category, an event ID, the third-party ID, a product line associated with the event, or a timestamp associated with the event.

12. The method of claim 9, wherein the aspect of the event comprises the reference to the event, the method comprising:
determining that the first data structure enables the efficient retrieval of the answer based on an event information; and
obtaining the answer by retrieving from the first data structure the event information.

13. A system comprising a processor configured to:
create a plurality of mutually referential data structures to increase accuracy and efficiency of attributing an event between a first-party ID and a second-party ID to a third-party ID, wherein at least one of the first-party ID and the second-party ID is associated with the third-party ID, by representing a plurality of aspects of the event using the plurality of mutually referential data structures and enabling efficient switching between different aspects of the event using references between the plurality of mutually referential data structures,
a first data structure in the plurality of mutually referential data structures representing a first aspect comprising a list of events between a plurality of first-party IDs and a plurality of second-party IDs, and
a second data structure in the plurality of mutually referential data structures representing a second aspect comprising an event category and a reference to the event in the list of events.

14. The system of claim 13, a third data structure representing a third aspect comprising a collection of most recent events including the event category, an event ID, a hash of the third-party ID and a product line ID associated with the event, and a timestamp associated with the event.

15. The system of claim 13, the first data structure comprising an event information and a timestamp associated with the event.

16. The system of claim 15, the first data structure comprising an event ID including a hash of the event information and the timestamp associated with the event.

17. The system of claim 13, the second data structure comprising the event category and a collection of events associated with the event category.

18. The system of claim 13, comprising the processor configured to:
receive a query comprising an aspect of the event;
obtain an answer to the query by finding a data structure in the plurality of mutually referential data structures enabling an efficient retrieval of the answer based on the aspect of the event; and
obtain the answer from the data structure.

19. The system of claim 18, wherein the aspect of the event comprises the third-party ID, the system comprising the processor configured to:
determine that the second data structure enables the efficient retrieval of the answer based on the third-party ID; and
obtain the answer by retrieving from the second data structure the event category or a collection of events associated with the event category.

20. The system of claim 18, wherein the aspect of the event comprises a time period, the system comprising the processor configured to:
determine that a third data structure comprising a collection of most recent events including the event category, a reference to an element of the second data structure and a reference to an element of the first data structure enables the efficient retrieval of the answer based on the time period; and
obtain the answer by retrieving from the third data structure the event category a first unique identifier associated with the event, the third-party ID and a product line associated with the event, the event category, and a timestamp associated with the event.
